(19) United States
(12) Patent Application Publication
(10) Pub. No.: US 2017/0306264 A1
(43) Pub. Date: Oct. 26, 2017

(54) BIOSURFACTANT-CONTAINING FORMULATION

(71) Applicant: EVONIK DEGUSSA GMBH, Essen (DE)

(72) Inventors: Jörg Peggau, Essen (DE); Ulrike Kottke, Linsengericht-Großenhousen (DE); Hans Henning Wenk, Mülheim an der Ruhr (DE); Dirk Kuppert, Aschaffenburg (DE); Jochen Kleinen, Heinsberg (DE)

(21) Appl. No.: 15/509,685

(22) PCT Filed: Sep. 2, 2015
(86) PCT No.: PCT/EP2015/070023

§ 371 Date: Mar. 8, 2017

(30) Foreign Application Priority Data
Sep. 30, 2014 (EP) 14186999.0

(51) Int. Cl. C11D 1/94; C11D 3/00; C11D 1/75; C11D 1/66; C11D 1/90; C11D 1/29

(52) U.S. Cl. CPC C11D 1/94; C11D 3/0094; C11D 1/29; C11D 1/667; C11D 1/90; C11D 1/75

(57) ABSTRACT

The present invention further relates to a biosurfactant-containing formulation including A) at least one biosurfactant, and B) at least one additional surfactant selected from the group of betaines, alkoxylated fatty alcohol sulphates and alkylamine oxides, wherein the biosurfactant-containing formulation may be used on hard surfaces.

### FIELD OF THE INVENTION

The invention relates to biosurfactant-containing formulations and use thereof as detergents with improved foam forming and fat dissolving capacity comprising at least one further surfactant.

### PRIOR ART

Commercial detergent compositions, which may also be used as hand dishwashing detergents, usually comprise combinations of surfactants in order to meet the demands of the consumer for cleaning performance and foam formation. In particular, the formulations, in addition to a high rinse performance, also have marked foam forming capacity and a rapid foaming capacity. It is particularly desirable that the compositions also exhibit marked foam forming behavior in the presence of fat and/or oil soiling, and that the foam has adequate stability also in the presence of soiling. Both impart high efficacy to the user. It is desirable, moreover, to have detergent compositions which remove fat- and/or oil-containing soiling effectively from, for example, stained surfaces. Therefore, there exists a need for improved detergent compositions which may be used as hand dishwashing detergents. In particular, there is interest in compositions which further improve the application-related appearance of the surfactants typically used.

EP1445302 discloses detergent compositions comprising at least one glycolipid biosurfactant and at least one non-glycolipid surfactant, characterized in that the at least one glycolipid biosurfactant and the at least one non-glycolipid surfactant are in the micellar phase. In this way, a reduced foaming effect of the surfactant is achieved, whereby an advantageous use in washing machines is enabled. The declared aim of EP14453021 are foam-poor formulations. It is shown in particular in the examples that the addition of sophorolipids to the anionic surfactant sodium lauryl sulphate (SLS) leads to reduction of the foam formation.

WO 2011/120776 describes a foaming detergent composition consisting of a) 1 to 20% by weight sophorolipid biosurfactant, b) 1 to 20% of an anionic surfactant selected from the group comprising glycinates, sulphosuccinates and mixtures thereof, c) 0 to 10% by weight of a foam booster, d) 0 to 2% by weight of an electrolyte, e) 0 to 10% by weight of an additional additive and 40 to 98% water. Only olive amidopropylbetaine is mentioned as foam booster, where no example or data on the foaming ability are listed. Furthermore, WO 2011/120776 discloses on page 8, lines 26-29, that surfactants other than the claimed surfactants should be present at less than 1% by weight in the formulations, and that alkyl sulphates and alkyl or aryl sulphonates should be completely avoided.

U.S. Pat. No 5,417,879 discloses combinations of glycolipids and non-glycolipid surfactants for the removal of oil and soiling. The preferred glycolipids mentioned are also sophorolipids. However, all examples with sophorolipids are in combination with non-ionic surfactants. Moreover, no data are given on the foaming ability.

DE 19600743 describes combinations of glycolipids with a long list of anionic surfactants, non-ionic surfactants and amphoteric surfactants. However, only examples of binary mixtures of a glycolipid with a non-glycolipid are listed. For sophorolipids in particular, only examples of binary mixtures with sodium lauryl sulphate as anionic surfactant are listed.

WO 2013/098066 is directed to a composition comprising water, at least one biosurfactant and at least one fatty acid, which is characterized in that the proportion of the sum total of all surfactants of the composition is from 1 to 30% by weight, and that the proportion of fatty acid based on the sum total of fatty acid and surfactants is from 0.1 to 20% by weight, and also use thereof for preparing bath additives, shower gel, shampoos, conditioners, body cleansers or skin cleansers.

It is advantageous for dishwashing detergent if these produce a lot of foam with long-term stability since this imparts high efficacy to the user.

The object of the present invention was to provide formulations with a sophorolipid which has excellent foaming behavior. Moreover, the formulations should also possess improved fat dissolving capacity, i.e. improved cleaning performance.

### DESCRIPTION OF THE INVENTION

Surprisingly, it has been found that the formulations described below are able to solve the problem addressed by the invention.

The present invention therefore relates to formulations comprising
A) at least one biosurfactant,
B) at least one additional surfactant selected from the group of betaines, alkoxylated fatty alcohol sulphates and alkylamine oxides.

The invention further provides for the use of the inventive formulations for foam stabilization.

An advantage of the present invention is that the formulations foam strongly, i.e. generates large foam volumes.

A further advantage of the present invention is that the formulations generate foams stable over time.

A further advantage of the present invention is that the formulations have good initial foaming behavior.

A further advantage of the present invention is that the formulations have good skin compatibility.

A further advantage of the present invention is that the formulations have good run-off behavior.

A further advantage of the present invention is that the formulations have good drying behavior.

A further advantage of the present invention is that the formulations also show an excellent foam-forming capacity in the presence of oil soiling.

Another advantage of the present invention is that strongly foaming formulations may be formulated, without the use of surfactants, which have been prepared with ethylene oxide, if in group B) only betaines, in particular alkyldimethylbetaines, alkylamidopropylbetaines and alkylamine oxides are selected.

In addition, there is an increasing desire in consumers for “PEG-free” formulations.

Preferred formulations according to the invention comprise a biosurfactant as component A) selected from the group of rhamnolipids and sophorolipids, in particular sophorolipids.

Sophorolipids may be used in accordance with the invention in their acid form or their lactone form. With regard to the term “acid form” of sophorolipids reference is made to the general formula (Ia) of EP2501813, and with regard to the term “lactone form” of sophorolipids reference is made to the general formula (Ib) of EP2501813.

To determine the content of sophorolipids in the acid or lactone form in a formulation, refer to EP 1 411 111 B1, page 8, paragraph [0053].

Preferred formulations according to the invention comprise a sophorolipid as component A) in which the ratio by weight of lactone form to acid form is in the range of 20:80 to 80:20, especially preferably in the ranges of 30:70 to 40:60.

Preferred betaines are selected from the group of alkylbetaines, alkylamidobetaines, imidazolinium betaines, sulphobetaines (INCI Sultaines) and phosphobetaines and preferably comply with the general formula (I)

R¹—[CO—X—(CH₂)ₙ]_{X—N+(R}²)(R³)—(CH₂)ₘ—[CH(OH)—CH₂]y−Y⁻ (I)

in which R¹ is a saturated or unsaturated C6-C22-alkyl residue, preferably C8-C18-alkyl residue, in particular a saturated C10-C16-alkyl residue, for example a saturated C12-C14-alkyl residue,
X is NH, NR⁴ where R⁴ is a C1-C4 alkyl residue, O or S,
n is a number from 1 to 10, preferably 2 to 5, especially 3,
x is 0 or 1, preferably 1,
R², R³ are each independently a C1-C4-alkyl residue, optionally hydroxy-substituted such as for example an hydroxyethyl residue, but particularly a methyl residue,
m is a number from 1 to 4, preferably 1, 2 or 3,
y is 0 or 1 and
Y is COO, SO₃, OPO(OR⁵)O or P(O)(OR⁵)O, where R⁵ is a hydrogen atom H or a C1-C4-alkyl residue.

The alkylbetaines and alkylamidobetaines, betaines of the formula I having a carboxylate group (Y⁻=COO⁻), are also called carbobetaines. Preferred betaines are the alkylbetaines of the formula (Ia), the alkylamidobetaines of the formula (Ib), the sulphobetaines of the formula (Ic) and the amidosulphobetaines of the formula (Id),

R¹—N⁺(CH₃)₂—CH₂COO⁻ (Ia)

R¹—CO—NH—(CH₂)₃—N⁺(CH₃)₂—CH₂COO⁻ (Ib)

R¹—N⁺(CH₃)₂—CH₂CH(OH)CH₂SO₃⁻ (Ic)

R¹—CO—NH—(CH₂)₃—N⁺(CH₃)₂—CH₂CH(OH)CH₂SO₃⁻ (Id)

in which R¹ has the same definitions as in formula I.

Particularly preferred betaines are the carbobetaines, particularly the carbobetaines of the formula (Ia) and (Ib), exceptionally preferably the alkylamidobetaines of the formula (Ib).

Examples of suitable betaines and sulphobetaines are the following compounds known according to INCI: Almondamidopropyl Betaine, Apricotamidopropyl Betaine, Avocadamidopropyl Betaine, Babassuamidopropyl Betaine, Behenamidopropyl Betaine, Behenyl Betaine, Betaine,Canolamidopropyl Betaine, Capryl/Capramidopropyl Betaine, Carnitine, Cetyl Betaine, Cocamidoethyl Betaine, Cocamidopropyl Betaine, Cocamidopropyl Hydroxysultaine, Coco-Betaine, Coco-Hydroxysultaine, Coco/Oleamidopropyl Betaine, Coco-Sultaine, Decyl Betaine, Dihydroxyethyl,Oleyl Glycinate, Dihydroxyethyl Soy Glycinate, Dihydroxyethyl Stearyl Glycinate, Dihydroxyethyl Tallow Glycinate, Dimethicone Propyl PG-Betaine, Erucamidopropyl Hydroxysultaine, Hydrogenated Tallow Betaine, Isostearamidopropyl Betaine, Lauramidopropyl Betaine, Lauryl Betaine, Lauryl Hydroxysultaine, Lauryl Sultaine, Milkamidopropyl Betaine, Minkamidopropyl Betaine, Myristamidopropyl Betaine, Myristyl Betaine, Oleamidopropyl Betaine, Oleamidopropyl Hydroxysultaine, Oleyl Betaine, Olivamidopropyl Betaine, Palmamidopropyl Betaine, Palmitamidopropyl Betaine, Palmitoyl Carnitine, Palm Kernelamidopropyl Betaine, Polytetrafluoroethylene Acetoxypropyl Betaine, Ricinoleamidopropyl Betaine, Sesamidopropyl Betaine, Soyamidopropyl Betaine, Stearamidopropyl Betaine, Stearyl Betaine, Tallowamidopropyl Betaine, Tallowamidopropyl Hydroxysultaine, Tallow Betaine, Tallow Dihydroxyethyl Betaine, Undecylenamidopropyl Betaine and Wheat Germamidopropyl Betaine.

An especially preferred betaine is, for example, Cocamidopropyl Betaine (cocoamidopropylbetaine).

Alkoxylated fatty alcohol sulphates, also alkyl ether sulphates, fatty alcohol ether sulphates or Alkyl Ether Sulphates according to INCI are products of sulphation reactions on alkoxylated alcohols. To those skilled in the art, alkoxylated alcohols are understood to be the reaction products of alkylene oxides, preferably ethylene oxide, with alcohols, in the context of the present invention preferably with longer-chain alcohols, i.e. with aliphatic straight-chain or mono- or multibranched, acyclic or cyclic, saturated or mono- or polyunsaturated, preferably straight-chain, acyclic saturated alcohols having 6 to 22, preferably 8 to 18, particularly 10 to 16 and particularly preferably 12 to 14 carbon atoms. Generally, a complex mixture of addition products of different degrees of ethoxylation (n=1 to 30, preferably 1 to 20, in particular 1 to 10, particularly preferably 2 to 4) are formed from n moles of ethylene oxide and one mole of alcohol, depending on the reaction conditions.

A further embodiment of the alkoxylation consists of the use of mixtures of alkylene oxides, preferably mixtures of ethylene oxide and propylene oxide.

In the context of the present invention, especially preferred are low-ethoxylated fatty alcohols having 1 to 4 ethylene oxide units (EO), particularly 1 to 2 EO, for example 2 EO, such as Na-C12-14-fatty alcohol +2EO sulphate, commonly known under the name lauryl ether sulphate.

Examples of suitable amine oxides include alkylamine oxides, in particular alkyldimethylamine oxides, alkylamidoamine oxides and alkoxyalkylamine oxides. Preferred amine oxides comply with formula II and III,

R⁶R⁷R⁸N⁺—O⁻ (II)

R⁶—[CO—NH—(CH₂)_{w}]_{z}—N⁺(R⁷)(R⁸)—O⁻ (III)

in which R⁶ is a saturated or unsaturated C6-22-alkyl residue, preferably C8-18-alkyl residue, in particular a saturated C10-16-alkyl residue, for example, a saturated C12-14-alkyl residue, which is bonded to the nitrogen atom N in the alkylamidoamine oxides via a carbonylamidoalkylene group —CO—NH—(CH₂)_{z}— and in the alkoxyalkylamine oxides via an oxyalkylene group —O—(CH₂)_{z}—, where z is in each case a number from 1 to 10, preferably 2 to 5, particularly 3,
R⁷, R⁸ are each independently a C1-C4-alkyl residue, optionally hydroxy-substituted such as for example an hydroxyethyl residue, particularly a methyl residue,

Examples of suitable amine oxides are the following compounds known according to INCI: Almondamidopropylamine Oxide, Babassuamidopropylamine Oxide, Behenamine Oxide, Cocamidopropyl Amine Oxide, Cocamidopropylamine Oxide, Cocamine Oxide, Coco-Morpholine Oxide, Decylamine Oxide, Decyltetradecylamine Oxide, Diaminopyrimidine Oxide, Dihydroxyethyl C8-10 Alkoxypropylamine Oxide, Dihydroxyethyl C9-11 Alkoxypropylamine Oxide, Dihydroxyethyl C12-15 Alkoxypropylamine Oxide, Dihydroxyethyl Cocamine Oxide, Dihydroxyethyl Lauramine Oxide, Dihydroxyethyl Stearamine Oxide, Dihydroxyethyl Tallowamine Oxide, Hydrogenated Palm Kernel Amine Oxide, Hydrogenated Tallowamine Oxide, Hydroxyethyl Hydroxypropyl C12-15 Alkoxypropylamine Oxide, Isostearamidopropylamine Oxide, Isostearamidopropyl Morpholine Oxide, Lauramidopropylamine Oxide, Lauramine Oxide, Methyl Morpholine Oxide, Milkamidopropyl Amine Oxide, Minkamidopropylamine Oxide, Myristamidopropylamine Oxide, Myristamine Oxide, Myristyl/Cetyl Amine Oxide, Octylamine Oxide, Oleamidopropylamine Oxide, Oleamine Oxide, Olivamidopropylamine Oxide, Palmitamidopropylamine Oxide, Palmitamine Oxide, PEG-3 Lauramine Oxide, Potassium Dihydroxyethyl Cocamine Oxide Phosphate, Potassium Trisphosphonomethylamine Oxide, Sesamidopropylamine Oxide, Soyamidopropylamine Oxide, Stearamidopropylamine Oxide, Stearamine Oxide, Tallowamidopropylamine Oxide, Tallowamine Oxide, Undecylenamidopropylamine Oxide and Wheat Germamidopropylamine Oxide.

Preferred amine oxides are, for example, Cocamidopropylamine Oxide (cocoamidopropylamine oxide) and Cocamine Oxide.

Preferred formulations according to the invention additionally comprise
C) at least one fatty acid.

Fatty acids which can be present in the compositions according to the invention are all known aliphatic, branched or unbranched, saturated or unsaturated carboxylic acids or (poly)hydroxycarboxylic acids, or di-, tri- or oligomers thereof. The composition according to the invention preferably comprises one or more (hydroxy)fatty acids selected from the group comprising formic acid, acetic acid, propionic acid, butyric acid, valeric acid, hexanoic acid (caproic acid), heptanoic acid (oenanthic acid, enanthic acid), octanoic acid (caprylic acid), pelargonic acid (nonanoic acid), decanoic acid (capric acid), undecanoic acid, dodecanoic acid (lauric acid), tridecanoic acid, tetradecanoic acid (myristic acid), pentadecanoic acid, palmitic acid (hexadecanoic acid), margaric acid (heptadecanoic acid), stearic acid (octadecanoic acid), nonadecanoic acid, arachidic acid (eicosanoic acid), behenic acid (docosanoic acid), tetracosanoic acid (lignoceric acid), cerotic acid (hexacosanoic acid),triacontanoic acid (melissic acid), isobutyric acid (2-methylpropanoic acid), 3-methylbutyric acid (isovaleric acid, 3-methylbutanoic acid),tubercolostearic acid (10-methyloctadecanoic acid), acrylic acid (propenoic acid), butenoic acid, [crotonic acid, (2E)-but-2-enoic acid], palmitoleic acid [(9Z)-hexadec-9-enoic acid], oleic acid [(9Z)-octadec-9-enoic acid], elaidic acid [(9E)-octadec-9-enoic acid], erucic acid [(13Z)-docos-13-enoic acid], sorbic acid [(2E,4E)-hexa-2,4-dienoic acid], linoleic acid [(9Z,12Z)-octadeca-9,12-dienoic acid], linolenic acid [(9Z,12Z,15Z)-octadeca-9,12,15-trienoic acid], elaeostearic acid [(9Z,11E,13E)-octadeca-9,11,13-trienoic acid], arachidonic acid [(5Z,8Z,11Z,14Z)-icosa-5,8,11,14-tetraenoic acid], eicosapentaenoic acid [(5Z,8Z,11Z,14Z,17Z)-icosa-5,8,11,14,17-pentaenoic acid], clupanodonic acid [(4Z,8Z,12Z,15Z,19Z)-docosa-4,8,12,15,19-pentaenoic acid], mandelic acid, lactic acid, hydroxysuccinic acid, citric acid, tartaric acid, β-hydroxydecanoic acid or dimers thereof, other fruit acids, ricinoleic acid and humic acids. Preferably, the composition according to the invention comprises one or more fatty acids selected from valeric acid, hexanoic acid (caproic acid), heptanoic acid (oenanthic acid, enanthic acid), octanoic acid (caprylic acid), pelargonic acid (nonanoic acid), decanoic acid (capric acid), dodecanoic acid (lauric acid), tetradecanoic acid (myristic acid), palmitic acid (hexadecanoic acid), margaric acid (heptadecanoic acid), stearic acid (octadecanoic acid), arachidic acid (eicosanoic acid), behenic acid (docosanoic acid), tetracosanoic acid (lignoceric acid), cerotic acid (hexacosanoic acid), triacontanoic acid (melissic acid), tubercolostearic acid (10-methyloctadecanoic acid), palmitoleic acid [(9Z)-hexadec-9-enoic acid], oleic acid [(9Z)-octadec-9-enoic acid], elaidic acid [(9E)-octadec-9-enoic acid], erucic acid [(13Z)-docos-13-enoic acid], sorbic acid [(2E,4E)-hexa-2,4-dienoic acid], linoleic acid [(9Z,12Z)-octadeca-9,12-dienoic acid], linolenic acid [(9Z,12Z,15Z)-octadeca-9,12,15-trienoic acid], elaeostearic acid [(9Z,11E,13E)-octadeca-9,11,13-trienoic acid], arachidonic acid [(5Z,8Z,11Z,14Z)-icosa-5,8,11,14-tetraenoic acid], eicosapentaenoic acid [(5Z,8Z,11Z,14Z,17Z)-icosa-5,8,11,14,17-pentaenoic acid] and clupanodonic acid [(4Z,8Z,12Z,15Z,19Z)-docosa-4,8,12,15,19-pentaenoic acid]. In the composition according to the invention, fatty acids are particularly preferably present which are based on renewable raw materials, in particular on animal or vegetable fats or oils, in particular dimeric β-hydroxydecanoic acid, oleic acid, palmitic acid, stearic acid and/or linoleic acid. Very particular preference is given to oleic acid.

Particularly preferred formulations according to the invention are characterized in that the weight ratio of sophorolipid in the lactone form to component C), in particular oleic acid, is from 50:1 to 80:1.

Especially preferred formulations according to the invention comprise a sophorolipid as component A) in which the ratio by weight of lactone form to acid form is in the range of 20:80 to 80:20, especially preferably in the ranges of 30:70 to 40:60, and the ratio by weight of sophorolipid in the lactone form to component C), which represents oleic acid, is from 50:1 to 80:1.

The pH of the formulations according to the invention may be adjusted by means of customary pH regulators, for example, acids such as mineral acids or citric acid and/or alkalis such as sodium or potassium hydroxide, wherein a range is from 3 to 11, preferably 4 to 9, in particular 5 to 8 and especially preferably 5.5 to 7.5, wherein the pH is determined at 25° C. To adjust and/or stabilize the pH, the formulation may comprise one or more buffer substances (INCI Buffering Agents), typically in amounts from 0.001 to 5% by weight, preferably 0.005 to 3% by weight, in particular 0.01 to 2% by weight, particularly preferably 0.05 to 1% by weight, exceptionally preferably 0.1 to 0.5% by weight, for example 0.2% by weight. Preference is given to buffer substances which are at the same time complexing agents or even chelating agents (chelators, INCI Chelating Agents). Particularly preferred buffer substances are citric acid or citrates, particularly sodium and potassium citrate, for example, trisodium citrate.2H₂O and tripotassium citrate.H₂O.

Preferred formulations according to the invention comprise an additional surfactant as component B) selected from the group of cocamidopropylbetaine, ethoxylated lauryl ether sulphate, particularly ethoxylated with 1 to 4 EO, cocamidopropylamine oxide and cocamine oxide.

Particularly preferred formulations according to the invention comprise a sophorolipid as component A) and an additional surfactant as component B) selected from the group of cocamidopropylbetaine, lauryl ether sulphate ethoxylated with 1 to 4 EO, cocamidopropylamine oxide and cocamine oxide.

Especially preferred formulations according to the invention comprise a sophorolipid as component A) and the additional surfactants cocamidopropylbetaine and lauryl ether sulphate ethoxylated with 1 to 4 EO as component B), wherein the ratio by weight of sophorolipid component A) to cocamidopropylbetaine and lauryl ether sulphate ethoxylated with 1 to 4 EO as component B) is preferably in a range from 5:95 to 95:5, preferably from 15:85 to 75:25 and especially preferably from 30:70 to 50:50. For this preferred embodiment, it is furthermore preferred that the ratio by weight of sophorolipid in the lactone form to component C), in particular oleic acid, is from 50:1 to 80:1.

Formulations according to the invention comprise component A) preferably at a concentration of from 0.01% by weight to 95% by weight, preferably from 0.1% by weight to 40% by weight, particularly preferably from 1% by weight to 20% by weight, the percentages by weight referring to the total formulation.

Formulations according to the invention comprise component B) preferably at a concentration of from 0.01% by weight to 95% by weight, preferably from 0.1% by weight to 50% by weight, particularly preferably from 1% by weight to 30% by weight, the percentages by weight referring to the total formulation.

The weight ratio of component A) to component B) in the formulation according to the invention is from 5:95 to 95:5, preferably from 15:85 to 75:25 and especially preferably from 30:70 to 50:50.

Formulations according to the invention comprise component A) and component B) in total preferably at a concentration of 0.01% by weight to 90% by weight, preferably from 0.1% by weight to 75% by weight, particularly preferably from 0.25% by weight to 50% by weight and especially preferably from 0.5% by weight to 40% by weight, wherein the percentages by weight refer to the total formulation.

If in group B) selection is made only from betaines and alkylamine oxides, formulations are particularly preferred which were obtained largely without the use of surfactants which have been prepared with ethylene oxide, and are also essentially polyglycol ether-free and free of alkoxylated compounds. The term “essentially free of alkoxylated compounds” and “essentially polyglycol ether-free”, in connection with the present invention, are understood to mean that the formulations have no notable amounts of alkoxylated compounds or compounds comprising polyglycol ethers which exert a surface-active effect. This is particularly understood to mean that these compounds are present in amounts of less than 1% by weight, preferably less than 0.1% by weight, particularly preferably less than 0.01% by weight, based on the total formulation, in particular no detectable amounts.

Further possible anionic surfactants present in the formulations according to the invention are known to those skilled in the art from the relevant prior art relating to detergents and cleaning compositions. These especially include aliphatic sulphates such as fatty alcohol sulphates, monoglyceride sulphates and also ester sulphonates (sulphofatty acid esters),lignosulphonates, alkylbenzenesulphonates, fatty acid cyanamides, anionic sulphosuccinic acid surfactants, fatty acid isethionates, acylaminoalkane sulphonates (fatty acid taurides), fatty acid sarcosinates, ether carboxylic acids and alkyl(ether) phosphates.

Moreover, the formulations may comprise further ingredients known to those skilled in the art. Further ingredients in the amounts customary to those skilled in the art are selected from the group of non-ionic surfactants, sugar surfactants, alkylpolygylcosides, cationic surfactants, water-soluble inorganic and/or organic salts, builder substances, polymeric polycarboxylates, water, organic solvents miscible with water, such as ethanol, propanol, isopropanol, glycols, ethylene glycol, 1,2-propylene glycol, thickeners, perfume, dyes.

Moreover, additives to improve the run-off and drying behavior, to adjust the viscosity, for stabilization and also further auxiliaries and additives customary for use in hand dishwashing detergents, for example UV stabilizers, perfume, pearlizing agents (INCI Opacifying Agents; for example gycol distearate, e.g. Cutina® AGS from Cognis, or mixtures comprising these, e.g. Euperlane® from Cognis), dyes, corrosion inhibitors, preservatives (e.g. 2-bromo-2-nitropropane-1,3-diol (CAS 52-51-7) also referred to in industry as Bronopol, commercially available, for example, as Myacide® BT or as Boots Bronopol BT from Boots, isothiazolinone derivatives such as chloromethylisothiazolinone (CMIT), methylisothiazolinone (MIT) or benzisothiazolinone (BIT)), organic salts, disinfectants, enzymes, pH modifiers and also skin feel improving or care additives (e.g. Dermatologically effective substances such as vitamin A, vitamin B2, vitamin B12, vitamin C, vitamin E, D-panthenol, sericerin, collagen partial hydrolysate, various vegetable protein partial hydrolysates, protein hydrolysate fatty acid condensates, liposomes, cholesterol, vegetable and animal oils such as lecithin, soybean oil and so on, plant extracts such as aloe vera, azulene, witch hazel extracts, algae extracts and so on, allantoin, AHA complexes), which may be present in amounts of typically not more than 5% by weight.

The invention further provides for the use of the inventive formulations, thus a surfactant combination comprising
A) at least one biosurfactant,
B) at least one additional surfactant selected from the group of betaines, alkoxylated fatty alcohol sulphates and alkylamine oxides for foam stabilization.

Components A) and B) and combinations thereof preferably used are those which were mentioned above as preferred present in the formulations according to the invention.

The weight ratio of component A) to component B) in the use according to the invention is from 5:95 to 95:5, preferably from 15:85 to 75:25 and especially preferably from 30:70 to 50:50.

The invention further provides for the use of the inventive formulations, thus a surfactant combination comprising
A) at least one biosurfactant,
B) at least one additional surfactant selected from the group of betaines, alkoxylated fatty alcohol sulphates and alkylamine oxides to remove fat and/or oil-containing stains from hard surfaces such as, but not exclusively, ceramic crockery.

The invention further provides for the use of the formulations according to the invention for improving the run-off behavior of water from hard surfaces, particularly ceramics, glass and/or plastic.

The invention further provides for the use of the formulations according to the invention for improving the drying behavior of hard surfaces, particularly drop-free run-off from ceramics, glass and/or plastic in particular.

The invention further provides for the use of the formulations according to the invention for preventing limescale spots, particularly on ceramics, glass and/or plastic.

The examples adduced hereinafter describe the present invention by way of example, without any intention that the invention, the scope of application of which is apparent from the entirety of the description and the claims, be restricted to the embodiments specified in the examples.

### EXAMPLES

### Example 1: Initial Foaming Behavior and Foam Volumes

The following combinations were tested with respect to their foaming behavior:

Test conditions: Sita foam measurement device
Total concentration of active substance(s)=0.5% by weight, T=30° C., water˜10° dH, pH˜6, 1500 rpm
The sophorolipid used was a sophorolipid “SL 18” from Ecover, which has an acid to lactone ratio of 70:30 and a lactone form to oleic acid ratio of 60:1

The sophorollipid used was a sophorolipid “SL 19” having an acid to lactone ratio of 70:30, which by addition of oleic acid (Oleic Acid, Cremer Oleo GmbH and Co. KG, Germany) has a lactone form to oleic acid ratio of 6.

SLES=sodium lauryl ether sulphate with 2 EO (Texapon® N 70 trade name of BASF SE,)
CAPB=cocoamidopropylbetaine, (Tego® Betaine C 60 (trade name of Evonik Industries AG,)
CAPAO=cocamidopropylamine oxide (REWOMINOX© B 204, trade name of Evonik Industries AG,)
LAO=cocamine oxide. (OXIDET DM-246, trade name of Kao Chemicals)

| | | Foaming | |
|---|---|---|---|
| | Composition | [Time to 1000 ml | |
| Compositions | (weight ratio) | volume] | Foaming ability |
| SLES | 100 | + | ++ |
| CAPB | 100 | + | ± |
| SL 18 | 100 | + | ++ |
| SL 19 | 100 | − | −− |
| CAPAO | 100 | + | + |
| LAO | 100 | + | + |
| CAPB/SL 18 | 75/25 | ++ | ++ |
| CAPB/SL 19 | 75/25 | + | + |
| CAPAO/SL 18 | 50/50 | ± | + |
| CAPAO/SL 19 | 50/50 | − | − |
| CAPAO/SL 18 | 75/25 | ± | ++ |
| CAPAO/SL 19 | 75/25 | − | − |
| LAO/SL 18 | 75/25 | + | ++ |
| LAO/SL 19 | 75/25 | − | − |

Completely surprisingly, it shows that the sophorolipids with a relatively high lactone to oleic acid ratio alone and in the selected combinations have excellent foam properties, which relates both to initial foaming behavior and the maximum foaming capacity. The formulations according to the invention have a virtually identically good initial foaming behavior and an identically good foam stability as the anionic surfactant SLES.

### Example 2: Falling Foam Under Soil Loading

The behavior under practical soil loading was determined in a falling foam experiment.

The formulations listed here were measured on their foaming behavior and foam stability based on the IKW falling foam method (Seife Öle Fette Wachse [Soap Oils Fats Waxes] Journal, 128. (2002). The method described therein was adapted as follows: A 2 liter plastic measuring cylinder was initially charged with 20 ml of a 0.02% by weight aqueous surfactant solution, wherein the % by weight of active substance refers to the surfactants present in the solution. From a height of 1 meter, 1 liter of water at 40° C. and ˜4° dH, was discharged from a dropping funnel in one shot into the measuring cylinder. It is to be noted here that the outlet opening of the dropping funnel is positioned exactly in the middle of the opening of the measuring cylinder. After the total amount of water had been added, the time was stopped and the volume of foam forming was recorded after 30 seconds and after 90 seconds. The 30 second value is characteristic of the initial foaming behavior and the 90 second value is characteristic of the foam stability.

If the foam formation took place with addition of soiling, 5 g of commercial sunflower oil was injected into the water jet. The foam height was recorded again after 30 and after 90 seconds.

SLES=Texapon® N 70 (trade name of BASF SE, sodium lauryl ether sulphate with 2 EO)

The sophorolipid used was a sophorolipid “SL 18” from Ecover, which has an acid to lactone ratio of 70:30 and a lactone form to oleic acid ratio of 60:1.

CAPB=Tego® Betaine C 60 (trade name of Evonik Industries AG, cocoamidopropylbetaine)

The numerical values in Table 1 give the proportion in terms of weight of respective surfactant with regard to the total concentration of 0.02% by weight. The foam value are mean values of three measurements in each case.

TABLE 1

| | | | | Foam in [ml] | Foam in [ml] |
|---|---|---|---|---|---|
| Formulation | SLES | CAPB | SL 18 | after 30 sec | after 90 sec |
| 1 | 70 | 30 | 0 | 773 | 706 |
| (comparative | | | | | |
| example) | | | | | |
| 2 | 70 | 22.5 | 7.5 | 1039 | 972 |
| 3 | 70 | 15 | 15 | 1132 | 1079 |
| 4 | 70 | 7.5 | 22.5 | 1079 | 1026 |
| 5 | 70 | 0 | 30 | 1079 | 1026 |
| 6 | 80 | 10 | 10 | 1199 | 1146 |
| 7 | 80 | 15 | 5 | 1252 | 1173 |
| 8 | 80 | 20 | 0 | 1093 | 1012 |
| (comparative | | | | | |
| example) | | | | | |

Table 1: Combinations were tested with respect to their foaming capacity without addition of soiling. Formulation 1 and 8 are non-inventive comparative examples.

It is distinctly evident from Table 1 that formulations according to the invention in which CAPB was partially or completely replaced with sophorolipid have a better initial foaming capacity and a better foam stability than surfactant combinations comprising only SLES and betaine, as is customary in the prior art.

### Example 3: Foaming Behavior and Foam Stability in the Presence of Soiling

Also important are the foaming behavior and the foam stability in the presence of customary household soiling. Table 2 shows formulations and their foaming ability in the presence of olive oil as soiling. The numerical values in Table 2 give the proportion in terms of weight of respective surfactant with regard to the total concentration of 0.02% by weight. The foam values are mean values of three measurements in each case.

TABLE 2

| | | | | Foam in [ml] | Foam in [ml] |
|---|---|---|---|---|---|
| Formulation | SLES | CAPB | SL 18 | after 30 sec | after 90 sec |
| 1 | 70 | 30 | 0 | 240 | 227 |
| (comparative | | | | | |
| example) | | | | | |
| 2 | 70 | 22.5 | 7.5 | 240 | 213 |
| 3 | 70 | 15 | 15 | 346 | 293 |
| 4 | 70 | 7.5 | 22.5 | 253 | 213 |
| 5 | 70 | 0 | 30 | 213 | 187 |

The examples show that the foaming ability under soiling has an optimum particularly at a ratio by weight of 70/15/15. Using data from Table 1, this combination is also the one with excellent foam-forming capacity without soiling.

### Example 4: Determination of the Fat Dissolving Power

The fat dissolving power was determined according to the following test scheme.

The test soiling used was a heavily fat- and oil-containing soiling of the following composition (data in % by weight)
2.5% coconut oil (Palmin)
2.5% beef tallow
2.5% olive oil
2.5% rapeseed oil
2.5% corn oil
2.5% milk powder
5% flour
80% isopropanol

The mixture was stained with Sudan red dye.

The soiling mixture was freshly applied before each experiment. As test object to be cleaned, commercially available white ceramic saucers with a diameter of 14 cm were used. The plates were cleaned in a commercially available dishwashing machine and rubbed with ethyl acetate to remove fat residues and allowed to dry overnight before use. Twenty plates were used for each experiment, which had been marked on the underside for unique identification. The soiling mixture was melted and 0.25 g of the liquid soiling was applied uniformly in a circular manner in thin layers in the middle of each plate. The plates are subsequently dried at 40° C. for twelve hours in the drying cabinet and, after cooling, weighed at room temperature.

To determine the cleaning performance, the plates are fixed at a 22° inclined plane and in each case 20 ml of a rinse solution (0.02% active surfactants) temperature-controlled at 40° C. were poured over. The rinse solution is applied in this case by means of a thin plastic hose on the upper edge of the soiling spots on the plates at a distance of 2 cm. Subsequently, the plates were post-rinsed with 20 ml of water temperature-controlled at 40° C. Due to the sloping tendency of the plates, the rinsing composition with the detached and dispersed soiling drains off. The plates are then placed upright for two hours on a draining board. Subsequently, the plates are in turn dried for 12 h in the drying cabinet at 40° C. The plates are weighed again after cooling to room temperature. The difference in plate mass with soiling before and after rinsing gives the cleaning performance. The cleaning performance is specified as a percentage based on the relative mass difference. The higher the mass difference, the better is the fat dissolving capacity of the formulation.

TABLE 3
Cleaning capacity/determination of the fat dissolving power

| Formulation | SLES | CAPB | SL 18 | Soiling removal in % |
|---|---|---|---|---|
| 1 | 70 | 30 | 0 | 38 |
| (comparative | | | | |
| example) | | | | |
| 3 | 70 | 15 | 15 | 49 |
| 5 | 70 | 0 | 30 | 49 |

It can be distinctly seen that formulations in which CAPB has been partially or completely replaced by SL has a higher cleaning capacity, i.e. a higher fat dissolving capacity.

Examples of hand dishwashing formulations (F1 to F5)

| Ingredients | F1 | F2 | F3 | F4 | F5 |
|---|---|---|---|---|---|
| SLES | 8.4 | 8.4 | 21.0 | 0 | 0 |
| CAPB | 0 | 1.8 | 3.5 | 3.0 | 0 |
| SL 18 | 3.6 | 1.8 | 3.5 | 9.0 | 9.0 |
| LAO | 0 | 0 | 0 | 0 | 3.0 |
| Thickener | 0.3 | 0.3 | 0 | 0.4 | 0.4 |
| Perfume | 0.2 | 0.2 | 0.1 | 0.1 | 0.1 |
| Dye | 0.01 | 0.01 | 0.01 | 0.01 | 0.01 |
| Water | to 100 | to 100 | to 100 | to 100 | to 100 |
| pH | 5.9 | 5.8 | 5.9 | 5.7 | 5.8 |

All data are specified in % by weight active substance, based on the formulation.
SLES=Texapon® N 70 (trade name of BASF SE, sodium lauryl ether sulphate with 2 EO)
SL 18: Sophorolipid from Ecover was used, which has an acid to lactone ratio of 70:30 and a lactone form to oleic acid ratio of 60:1.
CAPB=Tego® Betaine C 60 (trade name of Evonik Industries AG, cocoamidopropylbetaine)
LAO=cocamine oxide. (OXIDET DM-246, trade name of Kao Chemicals)
Thickener: Keltro®1 T (Xanthan Gum, trade name of CP Kelco)

The typical use concentration of the formulations F1, F2, F4 and F5 as hand dishwashing detergent are 5 g of formulation in 5 liters of water. The typical use concentration of the formulation F3 as hand dishwashing detergent are 3 g of formulation in 5 liters of water.

1. A formulation comprising
A) at least one biosurfactant,
B) at least one additional surfactant selected from the group of betaines, alkoxylated fatty alcohol sulphates and alkylamine oxides.

2. The formulation according to claim 1, wherein component A) is selected from the group of rhamnolipids and sophorolipids, particularly sophorolipids.

3. The formulation according to claim 1 wherein component B) is selected from the group of alkylbetaines, alkylamidobetaines, imidazolinium betaines, sulphobetaines and phosphobetaines.

4. The formulation according to claim 1, wherein said formulation further comprises
C) at least one fatty acid.

5. The formulation according to claim 4, wherein the weight ratio of sophorolipid in the lactone form to component C), in particular oleic acid, is from 50:1 to 80:1.

6. The formulation according to claim 1, wherein component B) is selected from the group of cocamidopropylbetaine, lauryl ether sulphates ethoxylated with 1 to 4 EO, cocamidopropylamine oxide and cocamine oxide.

7. The formulation according to claim 1, wherein
component A) comprises a sophorolipid and
component B) comprises cocamidopropylbetaine and lauryl ether sulphate ethoxylated with 1 to 4 EO.

8. The formulation according to claim 1, wherein component A) is present at a concentration of from 0.01% by weight to 95% by weight wherein the percentages by weight relate to the total formulation.

9. The formulation according to claim 1, wherein component B) is present at a concentration of from 0.01% by weight to 95% by weight wherein the percentages by weight relate to the total formulation.

10. The formulation according to claim 1, wherein the weight ratio of component A) to component B) in the formulation according to the invention is from 5:95 to 95:5.

11. The formulation according to claim 1, wherein component A) and component B) are present in total at a concentration of from 0.01% by weight to 90% by weight wherein the percentages by weight relate to the total formulation.

12. A foam stabilization comprising a formulation according to claim 1.

13. A method of removing fat- and/or oil-containing stains from hard surfaces, the method comprising applying the formulation according to claim 1 onto the hard surfaces.

14. A method of improving run-off behavior of water on hard surfaces, the method comprising applying the formulation according to claim 1 onto the hard surfaces.

15. A method of improving drying behavior of water on hard surfaces, the method comprising applying the formulation according to claim 1 onto the hard surfaces.

16. The formulation according to claim 1, wherein component A) is present at a concentration of from 0.1% by weight to 40% by weight, wherein the percentages by weight relate to the total formulation.

17. The formulation according to claim 1, wherein component B) is present at a concentration of from 0.1% by weight to 50% by weight, wherein the percentages by weight relate to the total formulation.

18. The formulation according to claim 1, wherein the weight ratio of component A) to component B) in the formulation according to the invention is from 15:85 to 75:25.

19. The formulation according to claim 1, wherein component A) and component B) are present in total at a concentration of from 0.1% by weight to 75% by weight, wherein the percentages by weight relate to the total formulation.

20. The formulation according to claim 2, wherein component B) is selected from the group of alkylbetaines, alkylamidobetaines, imidazolinium betaines, sulphobetaines and phosphobetaines.
